(19) United States
(12) Patent Application Publication
(10) Pub. No.: US 2020/0227929 A1
(43) Pub. Date: Jul. 16, 2020

(54) INDUCTIVE METHOD AND APPARATUS FOR BATTERY STORAGE

(71) Applicants: Richard Redpath, Cary, NC (US); James Redpath, Cary, NC (US)

(72) Inventors: Richard Redpath, Cary, NC (US); James Redpath, Cary, NC (US)

(21) Appl. No.: 16/572,642

(22) Filed: Sep. 17, 2019

Related U.S. Application Data
(60) Provisional application No. 62/791,812, filed on Jan. 13, 2019.

(51) Int. Cl. H02J 7/00; F21L 4/00

(52) U.S. Cl. CPC H02J 7/0063; H02J 2007/0067; F21L 4/005

(57) ABSTRACT

The present invention relates to a method and apparatus for preventing the draining of power for an enclosed reusable battery system deployed for a rechargeable flashlight for shipping and storage.

### FIELD OF THE INVENTION

The present invention relates to a battery-operated torch, e.g., flashlight, to secure safe for shipping and storage for intrinsic operation in an explosive environment. More specifically, the torch apparatus provides a magnetic inductive mechanism to cut off all power for shipping and long-term storage of rechargeable battery cells requiring special handling for dangerous goods transportation, especially in aircraft.

### BACKGROUND OF THE INVENTION

Although there are numerous portable light and light source modules for illumination, e.g. flashlights, the devices do not provide a utility and additional functionality for safe transport of their contained rechargeable lithium battery. Lithium batteries are classified as dangerous goods and, as such, require special packaging for transportation. All domestic and international shipments containing lithium batteries are subject to transport regulations on hazardous goods according to ADR RID, ADN, IMDG, ICAO/IATA Regulations. The batteries UN3480 are lithium ion batteries, rechargeable, without physical connectivity equipment. Further, the devices do not provide a non-mechanical intrinsically safe means to completely cut off power to provide long-term storage of a fully charged battery. Prior art used for Lithium batteries to ship safety require a State of Charge (SoC) of the battery or cell not to exceed 30% for transport. Further prior art is to provide a physical switch which precludes the device from operation in an explosive environment.

It is an object of the invention to provide a solution is used to safety ship the device with a fully charged battery instead of a State of Charge (SoC) of the battery or cell not to exceed 30% as typically done for transport. Another object of the invention is to permit the ability to store the device fully charge for duration of life for the battery charge to avoid discharge when connected to a circuit. Another object of the invention is for a solution intrinsically safe for operation in an explosive environment. Finally, another object of the invention is to provide an implementation that is ergonomic for reuse as well as convenient to carry as a wrist strap.

### BRIEF DESCRIPTION OF THE DRAWINGS

FIG. 1 is diagram of the ergonomic apparatus for the device to supply a magnetic field to a logic board to switch power off.

FIG. 2 is an illustration of the use of the apparatus as a wearable wrist strap.

FIG. 3 is a diagram of the use of the strap apparatus for a flashlight

FIG. 4 is a flowchart of the method to switch power off from a battery to a logically electrical system.

FIG. 5 is a diagram of the use of the cuff apparatus for a flashlight.

### DETAIL DESCRIPTIONS OF THE INVENTION

All illustrations of the drawings are for the purpose of describing selected versions of the present invention and are not intended to limit the scope of the present invention.

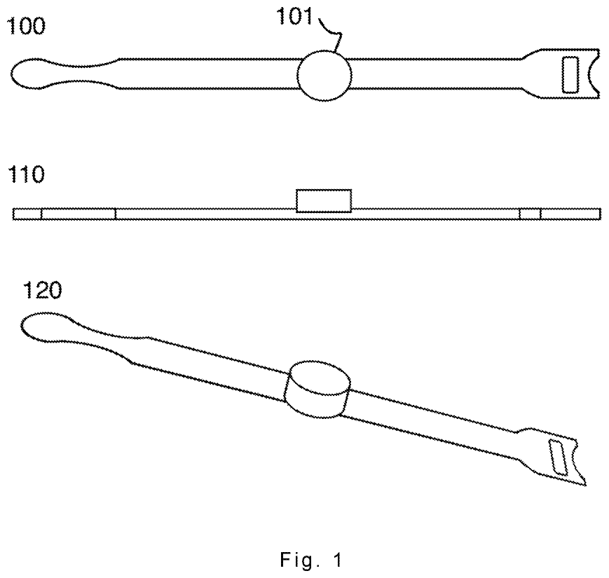

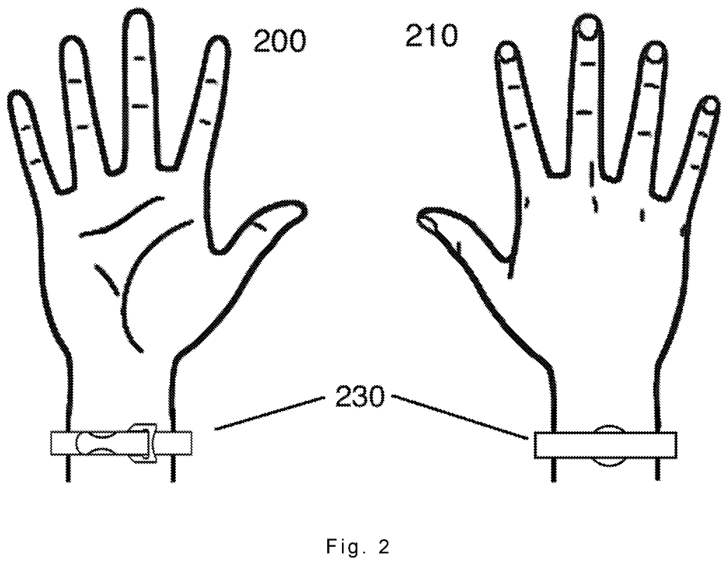

The invention is to use a magnetic field to an inductive switch to cut off power from the battery to the logic circuit of the device. Referring to FIG. 1 at 100, 110, and 120 are top, side and perspective views of a strap with a magnet at 101 attached. Referring to FIG. 2 at 200 and 210 is a bottom and top view of a hand with the strap in FIG. 1 at 100 worn by the hand at 200 and 210 views as shown in FIG. 2 at 230.

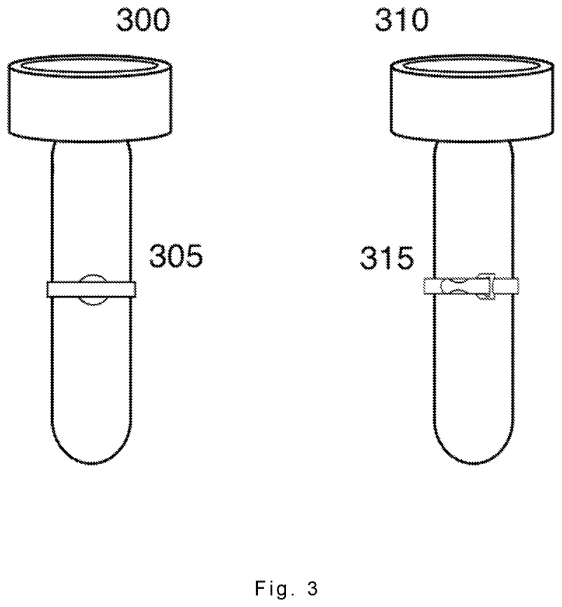

Referring to FIG. 3 at 300 and 310 is a top and bottom view of a flashlight. At 305 and 315 is a top and bottom view of the invention strapped onto the flashlight at 300 and 310 respectfully to use induction to switch off the battery connection.

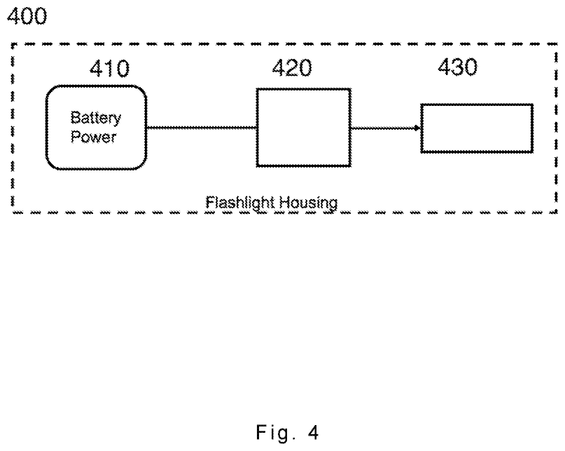

Referring to FIG. 4 is a flowchart of the internal logic for a device such as a flashlight. At 410 is a battery power supply which is connected to an induction switch at 420 which controls power to a logic board at 430. The induction switch at 420 normally provides power to the logic board at 430 unless a magnetic field is detected by a magnet in FIG. 1 at 101.

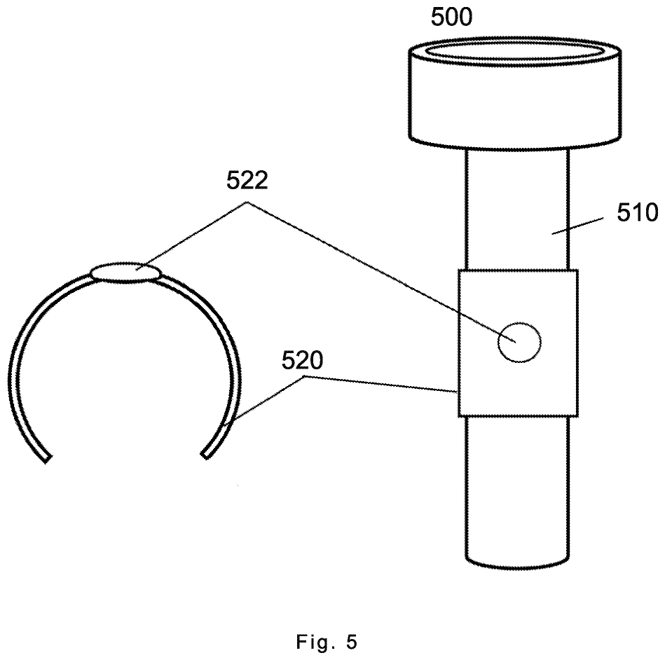

Referring to FIG. 5 at 500 is a flashlight. At 520 is a view of the invention as a cuff with embedded magnet at 522. At 500 is a flashlight with body at 510 having the cuff at 520 cuffed to use induction to switch off the battery connection.

Although the invention has been explained in relation to its preferred embodiment, it is to be understood that many other possible modifications and variations can be made without departing from the spirit and scope of the invention as herein after claimed.

What is claimed is:

1. A method and apparatus using a magnetic field to an inductive switch to power off from a battery to the logic board of a device.

2. A method and apparatus using a strap to hold a magnetic field to the inductive switch to power off
from a battery to the logic board of the device for ergonomic reuse.

3. A method and apparatus according to claim 1, using a packaging box for a device to hold a magnetic field to the inductive switch to power off from a battery to the logic board of a device for limited use.

4. A method and apparatus according to claim 2, using a sticker as a strap infrastructure to hold a magnetic field to the inductive switch to power off from a battery to the logic board of a device for limited use.

5. A method and apparatus according to claim 2, using a removable cuff as a strap infrastructure to hold a magnetic field to the inductive switch to power off from a battery to the logic board of a device for limited use.
